(19) United States
(12) Patent Application Publication
(10) Pub. No.: US 2024/0424352 A1
(43) Pub. Date: Dec. 26, 2024

(54) GOLF BALL

(71) Applicant: Sumitomo Rubber Industries, Ltd., Kobe-shi (JP)

(72) Inventors: Hidetaka INOUE, Kobe-shi (JP); Takahiro SAJIMA, Kobe-shi (JP); Kaita FUKAO, Kobe-shi (JP)

(73) Assignee: Sumitomo Rubber Industries, Ltd., Kobe-shi (JP)

(21) Appl. No.: 18/750,120

(22) Filed: Jun. 21, 2024

(30) Foreign Application Priority Data
Jun. 22, 2023 (JP) 2023-002195

(51) Int. Cl. A63B 37/00

(52) U.S. Cl. CPC A63B 37/0075; A63B 37/0017; A63B 37/0031; A63B 37/0033; A63B 37/0043; A63B 37/0045; A63B 37/00621; A63B 37/00622

(57) ABSTRACT

An object of the present disclosure is to provide a golf ball bending in a great amplitude and rolling a short distance after landing. The present disclosure provides a golf ball comprising a spherical core, an intermediate layer, and an outermost cover having a plurality of dimples formed thereon, wherein when a center hardness (Shore C hardness) of the spherical core is Ho, a surface hardness (Shore C hardness) of the spherical core is Hs, a hardness difference S=Hs−Ho, a material hardness (Shore D hardness) of the intermediate layer is Hm, a thickness of the intermediate layer is Tm (mm), a material hardness (Shore D hardness) of the outermost cover is Hc, a thickness of the outermost cover is Tc (mm), and a total lower volume of the plurality of dimples is Vi (mm³), [S×(Hm×Tm+Hc×Tc)]/(Tm+Tc)×Vi/1000<230 is satisfied.

### FIELD OF THE DISCLOSURE

The present disclosure relates to a golf ball, and particularly relates to a golf ball comprising a spherical core, an intermediate layer, an outermost cover and dimples.

### DESCRIPTION OF THE RELATED ART

In order to avoid obstacles or the like in the course, a high skilled golfer makes a draw shot or fade shot. The draw shot or fade shot is a shot that intentionally makes a golf ball curve to left or right, which can avoid obstacles.

In order to make the draw shot or fade shot, the shot technique of the golfer is important. On the other hand, it is important for a golf ball that the spin characteristics, aerodynamic characteristics or the like thereof are controlled to easily create a draw spin or fade spin.

For example, JP 2016-539779 A discloses a golf ball provided with hitting lines for making a fade shot and a draw shot, the golf ball comprising a plurality of dimples and a bonding line formed on an outer circumferential surface thereof, wherein a gravity center indication point for indicating the center of gravity of the golf ball is formed on an outer surface of the golf ball, a balance line passing through the gravity center indication point is formed thereon, and a fade line which guides the fade shot and a draw line which guides the draw shot are spaced apart by a constant distance and formed on both sides of the balance line, wherein the balance line passes through the gravity center indication point and is formed on an arbitrary line perpendicular to the bonding line.

JP 2007-190391 A discloses a golf ball having a specific relationship of ball spin rate, moment of inertia, lift force and drag force. The golf ball disclosed in JP 2007-190391 A comprises a core and a cover, wherein the golf ball comprises a moment of inertia of about 0.46 oz/in² or greater, the lift coefficient is greater than about 0.20, the drag coefficient is less than about 0.22 at a Reynolds Number of 145000.

### SUMMARY OF THE DISCLOSURE

When providing a side spin for hitting a draw ball, the ball rolls a long distance after falling, and there is a problem of stopping at the target point. An object of the present disclosure is to provide a golf ball curving to a large extent and rolling a short distance after landing.

The present disclosure that has solved the above problem provides a golf ball comprising a spherical core, an intermediate layer positioned outside the spherical core, and an outermost cover positioned outside the intermediate layer and having a plurality of dimples formed thereon, wherein
a hardness difference S(=Hs−Ho) between a center hardness Ho (Shore C hardness) of the spherical core and a surface hardness Hs (Shore C hardness) of the spherical core,
a material hardness Hm (Shore D hardness) of the intermediate layer,
a thickness Tm (mm) of the intermediate layer,
a material hardness Hc (Shore D hardness) of the outermost cover,
a thickness Tc (mm) of the outermost cover, and
a total lower volume Vi (mm³) of the plurality of dimples satisfy

[S×(Hm×Tm+Hc×Tc)]/(Tm+Tc)×Vi/1000<230.

The golf ball according to the present disclosure is configurated as above, and can create a great side spin, and at the same time, has a great lift force, resulting in a long flight duration. If the flight duration on a shot is long, the golf ball curves to a large extent. In addition, if the flight duration increases, the height of the highest point of the hit ball becomes great and the falling angle becomes sharp. If the falling angle of the golf ball becomes sharp, the rolling distance of the golf ball after landing can be suppressed.

According to the present disclosure, a golf ball curving to a large extent and rolling a short distance after landing on a draw shot or fade shot is provided.

### BRIEF DESCRIPTION OF THE DRAWINGS

FIG. 1 is a partially cutaway cross-sectional view showing a golf ball according to one embodiment of the present disclosure;

FIG. 2 is a front view of a dimple pattern formed on an outermost cover;

FIG. 3 is a plane view of a dimple pattern formed on an outermost cover;

FIG. 4 is an enlarged sectional view of dimples formed on an outermost cover; and

FIG. 5 is an illustration graph illustrating a bending amplitude test on a shot.

### DESCRIPTION OF THE PREFERRED EMBODIMENT

The present disclosure provides a golf ball comprising a spherical core, an intermediate layer positioned outside the spherical core, and an outermost cover positioned outside the intermediate layer and having a plurality of dimples formed thereon, wherein
a hardness difference S(=Hs−Ho) between a center hardness Ho (Shore C hardness) of the spherical core and a surface hardness Hs (Shore C hardness) of the spherical core,
a material hardness Hm (Shore D hardness) of the intermediate layer,
a thickness Tm (mm) of the intermediate layer,
a material hardness Hc (Shore D hardness) of the outermost cover,
a thickness Tc (mm) of the outermost cover, and
a total lower volume Vi (mm³) of the plurality of dimples satisfy

[S×(Hm×Tm+Hc×Tc)]/(Tm+Tc)×Vi/1000<230.

### (Construction of Golf Ball)

The golf ball according to the present disclosure comprises a spherical core, an intermediate layer positioned outside of the spherical core, and an outermost cover positioned outside of the intermediate layer and having a plurality of dimples formed thereon.

Examples of the construction of the golf ball include a three-piece golf ball composed of a single-layered spherical core, an intermediate layer covering the spherical core, and an outermost cover covering the intermediate layer; and a multi-piece golf ball (a four-piece golf ball, a five-piece golf ball, or the like) composed of a single-layered spherical core, two or more intermediate layers covering the spherical core, and an outermost cover covering the intermediate layers. It is noted that the intermediate layer is sometimes referred to as an inner cover or an outer core depending on the construction of the golf ball.

The construction of the spherical core may be a single-layered construction, or a multi-layered construction, and the single-layered construction is preferable.

The diameter of the spherical core is preferably 34.8 mm or more, more preferably 36.8 mm or more, and even more preferably 38.8 mm or more, and is preferably 42.2 mm or less, more preferably 41.8 mm or less, even more preferably 41.2 mm or less, and most preferably 40.8 mm or less. If the diameter of the spherical core falls within the above range, the golf ball has better flight distance performance or shot feeling.

When the spherical core has a diameter in the range from 34.8 mm to 42.2 mm, the compression deformation amount of the spherical core (shrinking amount of the spherical core along the compression direction) when applying a load from an initial load of 98 N to a final load of 1275 N to the spherical core is preferably 2.0 mm or more, more preferably 2.5 mm or more, and even more preferably 3.0 mm or more, and is preferably 5.0 mm or less, more preferably 4.5 mm or less, and even more preferably 4.0 mm or less. If the compression deformation amount falls within the above range, the shot feeling is better.

The surface hardness (Hs) of the spherical core is not particularly limited, but the surface hardness (Hs) is preferably 60 or more, more preferably 65 or more, and even more preferably 70 or more, and is preferably 95 or less, more preferably 90 or less, and even more preferably 85 or less in Shore C hardness. If the surface hardness (Hs) falls within the above range, better shot feeling on a shot is obtained.

The center hardness (Ho) of the spherical core is not particularly limited, but the center hardness (Ho) is preferably 45 or more, more preferably 47 or more, and even more preferably 49 or more, and is preferably 74 or less, more preferably 72 or less, and even more preferably 70 or less in Shore C hardness. If the center hardness (Ho) falls within the above range, better shot feeling on a shot is obtained.

The hardness difference S(=Hs−Ho) between the surface hardness (Hs) and the center hardness (Ho) of the spherical core is preferably 3 or more, more preferably 5 or more, and even more preferably 7 or more, and is preferably less than 20, more preferably 19 or less, and even more preferably 18 or less in Shore C hardness. If the hardness difference S is less than 20, the spin rate becomes higher and thus the controllability on various iron shots is better. If the hardness difference S is 3 or more, the flight distance on a driver shot is greater.

The hardness (H10) at the 10 mm point from the center of the spherical core in the radius direction is not particularly limited, but the hardness (H10) is preferably 60 or more, more preferably 62 or more, and even more preferably 64 or more, and is preferably 84 or less, more preferably 82 or less, and even more preferably 80 or less in Shore C hardness. If the hardness (H10) falls within the above range, better shot feeling on a shot is obtained.

In the spherical core of the present disclosure, the value (H10-Ho)/S is preferably more than 0.35, more preferably 0.38 or more, and even more preferably 0.40 or more, and is preferably less than 0.6, more preferably 0.58 or less, and even more preferably 0.56 or less. If the value (H10-Ho)/S falls within the above range, it indicates that the hardness of the core changes linearly. When the hardness of the core increases linearly, the core deforms smoothly on a shot, resulting in a better shot feeling on a driver shot.

The material hardness Hm of the intermediate layer composition constituting the intermediate layer is preferably 50 or more, more preferably 52 or more, and even more preferably 54 or more, and is preferably 73 or less, more preferably 72 or less, and even more preferably 70 or less in Shore D hardness. If the material hardness Hm is 50 or more, the flight distance is better since the resilience performance on a driver shot is sufficiently exerted, and if the material hardness Hm is 73 or less, the shot feeling is better when the golf ball is hit. It is noted that in the case of comprising a plurality of intermediate layers, the material hardness of the outermost intermediate layer is defined as Hm.

The thickness Tm of the intermediate layer is preferably 0.8 mm or more, more preferably 0.9 mm or more, and even more preferably 1.0 mm or more, and is preferably 3.0 mm or less, more preferably 2.7 mm or less, and even more preferably 2.5 mm or less. If the thickness Tm is 0.8 mm or more, the durability is better, and if the thickness Tm is 3.0 mm or less, better shot feeling on a shot is obtained. It is noted that in the case of comprising a plurality of intermediate layers, the thickness of the outermost intermediate layer is defined as Tm.

The material hardness Hc of the cover composition constituting the outermost cover is preferably 20 or more, more preferably 22 or more, and even more preferably 24 or more, and is preferably 40 or less, more preferably 39 or less, and even more preferably 38 or less in Shore D hardness. If the material hardness Hc is 20 or more, the spin rate on a driver shot is not excessively high and thus the flight distance performance is better, and if the material hardness Hc is 40 or less, the spin performance on an approach shot is better.

The thickness Tc of the outermost cover is preferably 0.4 mm or more, more preferably 0.5 mm or more, and even more preferably 0.6 mm or more, and is preferably 1.0 mm or less, more preferably 0.9 mm or less, and even more preferably 0.8 mm or less. If the thickness Tc is 0.4 mm or more, the spin performance on an approach shot is better, and if the thickness Tc is 1.0 mm or less, the spin rate on a driver shot is not excessively high and thus the flight distance performance is better.

### (Dimples)

The golf ball according to the present disclosure comprises an outermost cover having a plurality of dimples formed thereon. The dimples are concaves formed on the outermost cover. Next, the dimples formed on the outermost cover of the golf ball according to the present disclosure will be described with reference to the figures.

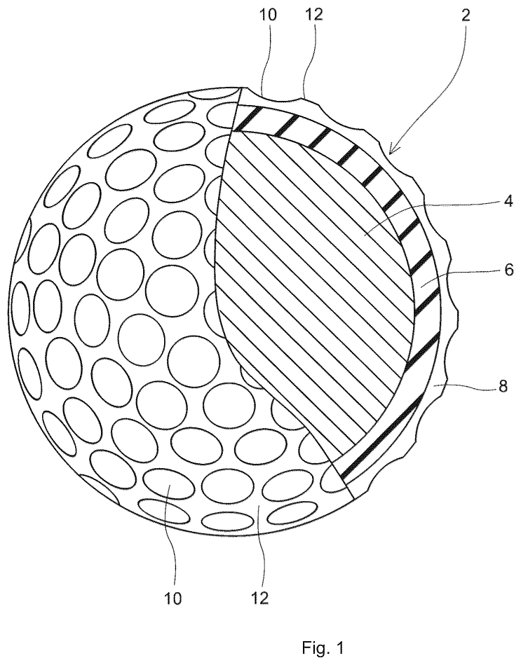

A golf ball 2 shown in FIG. 1 comprises a spherical core 4, an intermediate layer 6 covering the core 4, and an outermost cover 8 positioned outside the intermediate layer 6. The golf ball 2 has a plurality of dimples 10 on the surface. Other portions than the dimples 10 on the surface of the golf ball 2 are lands 12. The golf ball 2 is provided with a paint layer and a mark layer on an outer side of the outermost cover 8, but these layers are not depicted.

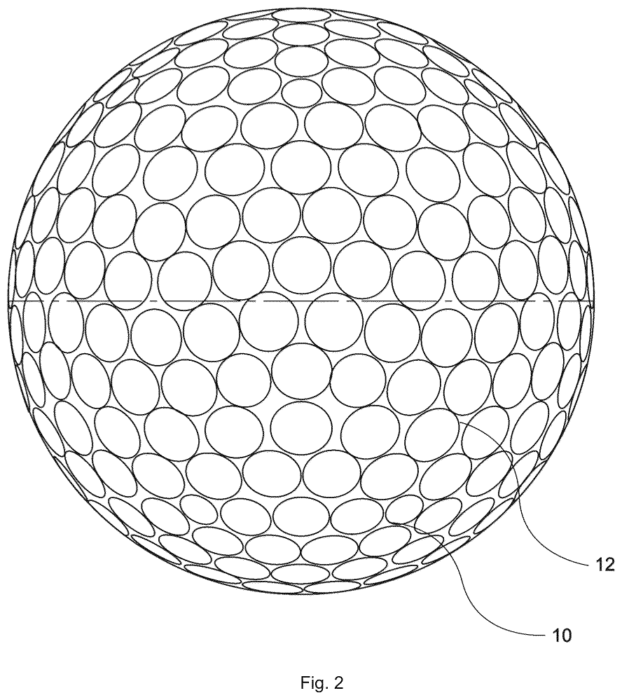

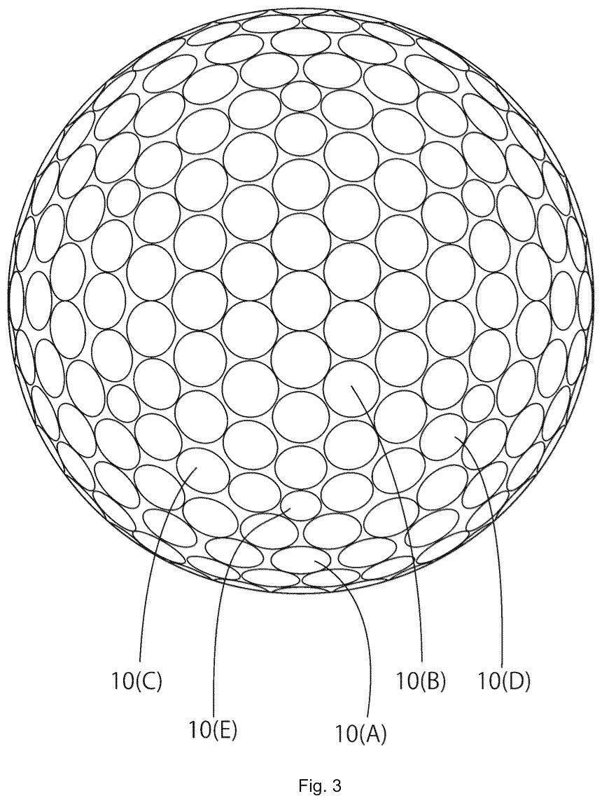

As shown in FIG. 2 and FIG. 3, the outermost cover of the golf ball 2 has a plurality of dimples 10 formed on the surface. Each of the dimples 10 has a circle contour.

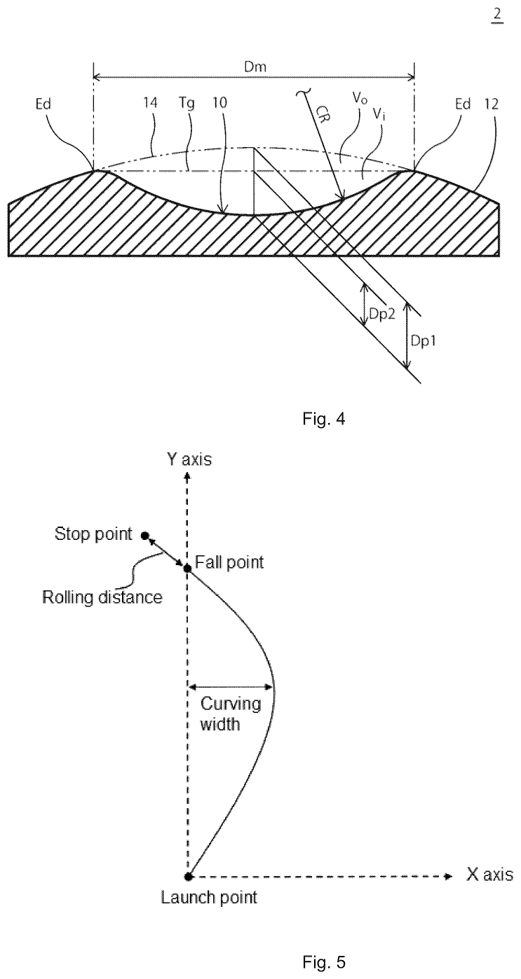

FIG. 4 shows a cross section of the golf ball 2 along a plane passing through the central point of the dimple 10 and the central point of the golf ball 2. The top-to-bottom direction in FIG. 4 is the depth direction of the dimple 10. In FIG. 4, a chain double-dashed line 14 indicates a virtual sphere. The surface of the virtual sphere 14 is the surface of the golf ball 2 when it is virtualized that no dimple 10 exists. The diameter of the virtual sphere 14 is equal to the diameter of the golf ball 2. The dimple 10 is recessed from the surface of the virtual sphere 14. The land 12 coincides with the surface of the virtual sphere 14. In the present embodiment, the cross-sectional shape of the dimple 10 is substantially a circular arc. The curvature radius of this circular arc is shown by a reference sign CR in FIG. 4.

In FIG. 4, an arrow Dm indicates the diameter of the dimple 10. The diameter Dm is a distance between one tangent point Ed and another tangent point Ed when a tangent line Tg traversing two sides of the dimple 10 is drawn. The tangent point Ed is also the edge of the dimple 10. The edge Ed defines the contour of the dimple 10.

In the present disclosure, the “volume of the dimple” means the volume of the portion surrounded by the surface of the dimple 10 and the surface of the virtual sphere including the contour of the dimple 10. The “volume of the dimple” is divided by a plane connecting intersection points Ed-Ed of the surface of the virtual sphere 14 with the surface of the dimple. The “upper volume of the dimple” is the volume of the dimple upper part surrounded by the surface of the virtual sphere 14 and the plane connecting the intersection points Ed-Ed of the surface of the dimple. The “lower volume of the dimple” is the volume of the dimple lower part surrounded by the plane connecting the intersection points Ed-Ed of the surface of the dimple and the surface of the dimple 10. The volume of the dimple is the sum of the upper volume and the lower volume. The “total volume V of the dimples” in the present disclosure is the sum of the volume of all the dimples. The “total upper volume Vo of the dimples” is the sum of the upper volume of all the dimples. The “total lower volume Vi of the dimples” is the sum of the lower volume of all the dimples. When the total upper volume of the dimples is Vo, and the total lower volume of the dimples is Vi, so V=Vo+Vi.

The total lower volume Vi of the plurality of dimples of the golf ball is preferably 190 mm³ or more, more preferably 195 mm³ or more, and even more preferably 200 mm³ or more. If the total lower volume Vi is 190 mm³ or more, the lift force that acts upon the golf ball by the backspin is suppressed, and the excess lift on a shot is suppressed. The total lower volume Vi is preferably less than 300 mm³, more preferably 295 mm³ or less, and even more preferably 290 mm³ or less. If the total lower volume Vi is less than 300 mm³, the lift force that acts upon the golf ball on a shot is greater, and the flight duration is longer.

The diameter Dm of the dimple 10 is preferably 2.0 mm or more, more preferably 2.5 mm or more, and even more preferably 2.8 mm or more, and is preferably 6.0 mm or less, more preferably 5.5 mm or less, and even more preferably 5.0 mm or less. If the diameter Dm is 2.0 mm or more, the dimples easily contribute to the turbulence, and if the diameter Dm is 6.0 mm or less, the nature of the golf ball that is substantially a spherical body can be kept.

The plurality of dimples may be a plurality of dimples with a single diameter, or a combination of dimples with various types of diameters. The golf ball 2 shown in FIG. 2 and FIG. 3 has five types of dimples, i.e. a dimple A with a diameter of 4.400 mm, a dimple B with a diameter of 4.285 mm, a dimple C with a diameter of 4.150 mm, a dimple D with a diameter of 3.875 mm, and a dimple E with a diameter of 3.000 mm.

In FIG. 4, a double ended arrow Dp1 indicates a first depth of the dimple 10. The first depth Dp1 is the distance between the deepest part of the dimple 10 and the surface of the virtual sphere 14.

The first depth Dp1 is preferably 0.15 mm or more, more preferably 0.17 mm or more, and even more preferably 0.20 mm or more, and is preferably 0.45 mm or less, more preferably 0.43 mm or less, and even more preferably 0.40 mm or less. If the first depth Dp1 is 0.15 mm or more, the lift force obtained by the dimples fully occurs, and if the first depth Dp1 is 0.45 mm or less, the nature of the golf ball that is substantially a spherical body can be kept.

In FIG. 4, a double ended arrow Dp2 indicates a second depth of the dimple 10. The second depth Dp2 is the distance between the deepest part of the dimple 10 and the tangent line Tg.

The second depth Dp2 is preferably 0.08 mm or more, more preferably 0.10 mm or more, and even more preferably 0.12 mm or more, and is preferably 0.30 mm or less, more preferably 0.28 mm or less, and even more preferably 0.26 mm or less. If the second depth Dp2 is 0.08 mm or more, the dimples easily contribute to the turbulence, and if the second depth Dp2 is 0.30 mm or less, the lift force obtained by the dimples is not excessively great, and the flight distance performance on a shot is better.

The area A of the dimple 10 is the area of a region surrounded by the contour of the dimple 10 when the central point of the golf ball 2 is viewed at infinity. In the case that the dimple 10 has a circular shape, the area A is calculated by the following mathematical formula.

$$A = π \times {( Dm / 2 )}^{2}$$

In the golf ball 2 shown in FIG. 2 and FIG. 3, the area of the dimple A is 15.21 mm², the area of the dimple B is 14.42 mm², the area of the dimple C is 13.53 mm², the area of the dimple D is 11.79 mm², and the area of the dimple E is 7.07 mm².

The ratio (total areas of dimples/surface area of virtual sphere) of the sum of the areas A of all the dimples 10 to the surface area of the virtual sphere 14 is referred to as an occupation ratio So. The occupation ratio So is preferably 70% or more, more preferably 75% or more, and even more preferably 80% or more, and is preferably 95% or less, more preferably 92% or less, and even more preferably 90% or less. If the occupation ratio So falls within the above range, the effect of the turbulence by the dimples is greater.

The number of the dimples can be appropriately adjusted depending on the diameter or occupation ratio of the dimples. It is noted that from the viewpoint of the occupation ratio or the function of the respective dimple, the total number of the dimples 10 is preferably 250 or more, more preferably 280 or more, and even more preferably 300 or more, and is preferably 450 or less, more preferably 410 or less, and even more preferably 390 or less.

The golf ball according to the present disclosure satisfies [S×(Hm×Tm+Hc×Tc)]/(Tm+Tc)×Vi/1000<230. Here, S is the hardness difference between the surface hardness Hs (Shore C) and the center hardness Ho (Shore C) of the spherical core, Hm is the material hardness (Shore D) of the intermediate layer, Tm is the thickness (mm) of the intermediate layer, Hc is the material hardness (Shore D) of the outermost cover, Tc is the thickness (mm) of the outermost cover, and Vi is the total lower volume (mm³) of the dimples. The value {[S×(Hm×Tm+Hc×Tc)]/(Tm+Tc)× Vi/1000} is preferably 110 or more, more preferably 120 or more, and even more preferably 130 or more, and is preferably less than 230, more preferably 225 or less, and even more preferably 220 or less.

If the value {[S×(Hm×Tm+Hc×Tc)]/(Tm+Tc)×Vi/1000} is less than 230, it is easier to create a side spin of the golf ball, and the golf ball curves to a large extent. If the value {[S×(Hm×Tm)+(Hc×Tc)]/(Tm+Tc)×Vi/1000} is 110 or more, the flight distance on a driver shot is increased.

The product (Hm×Tm) obtained by multiplying the material hardness Hm (Shore D hardness) of the intermediate layer by the thickness Tm (mm) of the intermediate layer is preferably 50 or more, more preferably 55 or more, and even more preferably 60 or more, and is preferably 140 or less, more preferably 130 or less, and even more preferably 120 or less. If the product (Hm×Tm) is 50 or more, the flight distance performance is better due to the low spin rate on a driver shot, and if the product (Hm×Tm) is 140 or less, better shot feeling on a shot is obtained.

The product (Hc×Tc) obtained by multiplying the material hardness Hc (Shore D hardness) of the outermost cover by the thickness Tc (mm) of the outermost cover is preferably 10 or more, more preferably 12 or more, and even more preferably 14 or more, and is preferably 45 or less, more preferably 42 or less, and even more preferably 40 or less. If the product (Hc×Tc) is 10 or more, the spin rate is stable due to the stable cover deformation amount on an approach shot, and if the product (Hc×Tc) is 45 or less, the ball has better resilience performance.

The value (Tm+Tc) is preferably 1.2 or more, more preferably 1.3 or more, and even more preferably 1.4 or more, and is preferably 3.5 or less, more preferably 3.3 or less, and even more preferably 3.1 or less. If the value (Tm+Tc) falls within the above range, better shot feeling on a shot is obtained.

The golf ball according to the present disclosure preferably satisfies the following relationship: the surface hardness Hs (Shore C hardness) of the spherical core<the surface hardness Hms (Shore C hardness) of the intermediate layer>the surface hardness Hos (Shore C hardness) of the golf ball. If the surface hardness Hms of the intermediate layer is greater than the surface hardness Hs of the spherical core, the outer-hard and inner-soft degree is greater, and thus the spin rate is suppressed and the flight distance is greater on a driver shot. If the surface hardness Hos of the golf ball is smaller than the surface hardness Hms of the intermediate layer, the spin rate is greater on approach shot and thus the controllability is greater.

The difference (Hms−Hcs) between the surface hardness Hms of the intermediate layer and the surface hardness Hcs of the golf ball is preferably more than 0, more preferably 2 or more, and even more preferably 4 or more in Shore C hardness. If the difference (Hms−Hcs) is more than 0, the spin performance on an approach shot is better, since the deformation of the cover when the golf ball is hit is greater. It is noted that the upper limit of the difference (Hms−Hcs) is not particularly limited, but it is about 20 in Shore C hardness.

The difference (Hms−Hs) between the surface hardness Hms of the intermediate layer and the surface hardness Hs of the spherical core is preferably more than 0, more preferably 2 or more, and even more preferably 4 or more in Shore C hardness. If the difference (Hms−Hs) is more than 0, the intermediate layer-covering spherical body having the intermediate layer formed on the surface of the spherical core has a greater outer-hard and inner-soft degree as a whole, and the spin rate on a driver shot can be suppressed.

The golf ball according to the present disclosure preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, and particularly preferably 42.80 mm or less. In addition, the golf ball according to the present disclosure preferably has a mass of 40 g or more and 50 g or less. In light of obtaining greater inertia, the mass is more preferably 44 g or more, and particularly preferably 45.00 g or more. In light of satisfying the regulation of USGA, the mass is particularly preferably 45.93 g or less.

When the golf ball has a diameter in the range of from 40 mm to 45 mm, the compression deformation amount (shrinking amount along the compression direction) of the golf ball when applying a load from an initial load of 98 N to a final load of 1275 N to the golf ball is preferably 2.0 mm or more, more preferably 2.1 mm or more, and even more preferably 2.2 mm or more, and is preferably 3.0 mm or less, more preferably 2.9 mm or less, and even more preferably 2.8 mm or less. If the compression deformation amount falls within the above range, the golf ball has better shot feeling.

Next, the materials for forming the constituent members of the golf ball according to the present disclosure will be explained.

### (Core Composition)

The spherical core of the golf ball according to the present disclosure is preferably formed from a rubber composition (hereinafter sometimes referred to as “core rubber composition”) containing (a) a base rubber, (b) an α,β-unsaturated carboxylic acid having 3 to 8 carbon atoms and/or a metal salt thereof as a co-crosslinking agent, and (c) a crosslinking initiator.

As (a) the base rubber, a natural rubber and/or a synthetic rubber can be used. For example, a polybutadiene rubber, a natural rubber, a polyisoprene rubber, a styrene polybutadiene rubber, or an ethylene-propylene-diene rubber (EPDM) can be used. These rubbers may be used solely, or at least two of these rubbers may be used in combination.

(b) The α,β-unsaturated carboxylic acid having 3 to 8 carbon atoms and/or the metal salt thereof is blended as a co-crosslinking agent in the rubber composition, and has an action of crosslinking a rubber molecule by graft polymerization to a base rubber molecular chain.

Examples of the α,β-unsaturated carboxylic acid having 3 to 8 carbon atoms include acrylic acid, methacrylic acid, fumaric acid, maleic acid and crotonic acid.

Examples of the metal ion constituting the metal salt of the α,β-unsaturated carboxylic acid having 3 to 8 carbon atoms include a monovalent metal ion such as sodium, potassium and lithium; a divalent metal ion such as magnesium, calcium, zinc, barium and cadmium; a trivalent metal ion such as aluminum; and other metal ions such as tin and zirconium. The above metal component may be used solely or as a mixture of at least two of them. Among them, the divalent metal ion such as magnesium, calcium, zinc, barium and cadmium is preferably used as the metal component. This is because if the divalent metal salt of the α,β-unsaturated carboxylic acid having 3 to 8 carbon atoms is used, a metal crosslinking easily generates between the rubber molecules. Especially, as the divalent metal salt, zinc acrylate is preferable, because zinc acrylate enhances the resilience of the obtained golf ball. It is noted that the α,β-unsaturated carboxylic acid having 3 to 8 carbon atoms and/or the metal salt thereof may be used solely or as a mixture of at least two of them.

The amount of (b) the α,β-unsaturated carboxylic acid having 3 to 8 carbon atoms and/or the metal salt thereof may be appropriately adjusted depending on the desired hardness of the spherical core. For example, the amount of the component (b) is preferably 15 parts by mass or more, more preferably 20 parts by mass or more, and even more preferably 25 parts by mass or more, and is preferably 50 parts by mass or less, more preferably 45 parts by mass or less, and even more preferably 40 parts by mass or less, with respect to 100 parts by mass of (a) the base rubber.

(c) The crosslinking initiator is blended to crosslink (a) the base rubber component. As (c) the crosslinking initiator, an organic peroxide is suitable. Specific examples of the organic peroxide include dicumyl peroxide, 1,1-bis(t-butylperoxy)-3,3,5-trimethylcyclohexane, 2,5-dimethyl-2,5-di(t-butylperoxy) hexane and di-t-butyl peroxide. These organic peroxides may be used solely or as a mixture of at least two of them. Among them, dicumyl peroxide is preferably used.

The amount of (c) the crosslinking initiator may be appropriately adjusted depending on the desired hardness of the spherical core. For example, the amount of (c) the crosslinking initiator is preferably 0.2 part by mass or more, more preferably 0.4 part by mass or more, and even more preferably 0.6 part by mass or more, and is preferably 5.0 parts by mass or less, more preferably 2.5 parts by mass or less, and even more preferably 1.0 part by mass or less, with respect to 100 parts by mass of (a) the base rubber.

In the case that the co-crosslinking agent of the rubber composition consists of the α,β-unsaturated carboxylic acid having 3 to 8 carbon atoms, the rubber composition preferably further contains (d) a metal compound. This is because if the α,β-unsaturated carboxylic acid having 3 to 8 carbon atoms is neutralized with the metal compound in the rubber composition, substantially the same effect as using the metal salt of the α,β-unsaturated carboxylic acid having 3 to 8 carbon atoms as the co-crosslinking agent is provided. In addition, in the case that the α,β-unsaturated carboxylic acid having 3 to 8 carbon atoms and the metal salt thereof are used in combination as the co-crosslinking agent, (d) the metal compound may be used.

(d) The metal compound is not particularly limited, as long as it can neutralize (b) the α,β-unsaturated carboxylic acid having 3 to 8 carbon atoms in the rubber composition. Examples of (d) the metal compound include a metal hydroxide such as magnesium hydroxide, zinc hydroxide, calcium hydroxide, sodium hydroxide, lithium hydroxide, potassium hydroxide, and copper hydroxide; a metal oxide such as magnesium oxide, calcium oxide, zinc oxide, and copper oxide; and a metal carbonate such as magnesium carbonate, zinc carbonate, calcium carbonate, sodium carbonate, lithium carbonate, and potassium carbonate. As (d) the metal compound, the divalent metal compound is preferable, the zinc compound is more preferable. This is because the divalent metal compound reacts with the α,β-unsaturated carboxylic acid having 3 to 8 carbon atoms to form a metal crosslinking. (d) The metal compound may be used solely, or at least two of them may be used in combination.

The rubber composition may further contain (e) an organic sulfur compound. (e) The organic sulfur compound enhances the resilience of the spherical core. (e) The organic sulfur compound is not particularly limited, as long as it is an organic compound having a sulfur atom in the molecule thereof. Examples of (e) the organic sulfur compound include an organic compound having a thiol group (—SH) or a polysulfide bond having 2 to 4 sulfur atoms (—S—S—, —S—S—S—, or —S—S—S—S—), and a metal salt thereof (—SM, —S-M-S— or the like; M is a metal atom). (e) The organic sulfur compound may be used solely or as a mixture of at least two of them.

Examples of (e) the organic sulfur compound include thiophenols, thionaphthols, polysulfides, thiurams, thiocarboxylic acids, dithiocarboxylic acids, sulfenamides, dithiocarbamates, and thiazoles. As the organic sulfur compound, diphenyl disulfides (e.g. diphenyl disulfide, bis(pentabromophenyl) disulfide), thiophenols, and thionaphthols (e.g. 2-thionaphthol) can be suitably used.

The amount of (e) the organic sulfur compound may be appropriately adjusted depending on the desired resilience performance of the spherical core. For example, the amount of (e) the organic sulfur compound is preferably 0.05 part by mass or more, more preferably 0.1 part by mass or more, and even more preferably 0.2 part by mass or more, and is preferably 5.0 parts by mass or less, more preferably 3.0 parts by mass or less, and even more preferably 1.0 part by mass or less, with respect to 100 parts by mass of (a) the base rubber.

The rubber composition may further contain (f) a carboxylic acid and/or a metal salt thereof. As (f) the carboxylic acid and/or the metal salt thereof, a carboxylic acid having 1 to 30 carbon atoms and/or a metal salt thereof is preferable. As the carboxylic acid, an aliphatic carboxylic acid (a saturated fatty acid or an unsaturated fatty acid), or an aromatic carboxylic acid (e.g. benzoic acid) can be used. The amount of (f) the carboxylic acid and/or the metal salt thereof is preferably 1 part by mass or more and 40 parts by mass or less with respect to 100 parts by mass of the base rubber.

The rubber composition may further contain an additive such as a filler for adjusting weight or the like, an antioxidant, a peptizing agent, and a softener, where necessary.

The filler blended in the rubber composition is mainly used as a weight adjusting agent for adjusting the weight of the golf ball obtained as a final product, and may be blended where necessary. Examples of the filler include an inorganic filler such as barium sulfate, calcium carbonate, magnesium oxide, tungsten powder, and molybdenum powder.

The rubber composition can be obtained by kneading (a) the base rubber, (b) the α,β-unsaturated carboxylic acid having 3 to 8 carbon atoms and/or the metal salt thereof, (c) the crosslinking initiator, and the other optional components. The kneading method is not particularly limited. For example, the kneading can be conducted with a conventional kneading machine such as a kneading roll, a banbury mixer and a kneader.

The spherical core can be molded, for example, by heat pressing the core rubber composition. The molding conditions for heat pressing the core rubber composition may be determined appropriately depending on the rubber composition. Generally, the heat pressing is preferably carried out at a temperature of 130° C. to 200° C. for 10 to 60 minutes, or carried out in a two-step heating of heating at a temperature of 130° C. to 150° C. for 20 to 40 minutes followed by heating at a temperature of 160° C. to 180° C. for 5 to 15 minutes.

### (Cover Composition and Intermediate Layer Composition)

The golf ball according to the present disclosure has an intermediate layer covering the spherical core. The intermediate layer is preferably formed from an intermediate layer composition containing a resin component.

The golf ball according to the present disclosure has an outermost cover positioned outside of the intermediate layer. The outermost cover is preferably formed from a cover composition containing a resin component.

Examples of the resin component used in the resin composition forming the outermost cover and the intermediate layer include an ionomer resin, a urethane resin (a thermoplastic polyurethane elastomer or a thermosetting polyurethane elastomer), a thermoplastic styrene elastomer, a thermoplastic polyamide elastomer, and a thermoplastic polyester elastomer.

Examples of the ionomer resin include a binary ionomer resin prepared by neutralizing at least a part of carboxyl groups in a binary copolymer composed of an olefin and an α,β-unsaturated carboxylic acid having 3 to 8 carbon atoms with a metal ion, a ternary ionomer resin prepared by neutralizing at least a part of carboxyl groups in a ternary copolymer composed of an olefin, an α,β-unsaturated carboxylic acid having 3 to 8 carbon atoms and an α,β-unsaturated carboxylic acid ester with a metal ion, and a mixture of those.

Examples of the binary ionomer resin include Himilan (registered trademark) 1555 (Na), 1557 (Zn), 1605 (Na), 1706 (Zn), 1707 (Na), AM7311 (Mg), AM7329 (Zn), AM7337 (available from Dow-Mitsui Polychemicals Co., Ltd.); Surlyn (registered trademark) 8945 (Na), 9945 (Zn), 8140 (Na), 8150 (Na), 9120 (Zn), 9150 (Zn), 6910 (Mg), 6120 (Mg), 7930 (Li), 7940 (Li), AD8546 (Li) (available from E.I. du Pont de Nemours and Company); and lotek (registered trademark) 8000 (Na), 8030 (Na), 7010 (Zn), 7030 (Zn) (available from ExxonMobil Chemical Corporation).

Examples of the ternary ionomer resin include Himilan AM7327 (Zn), 1855 (Zn), 1856 (Na), AM7331 (Na) (available from Dow-Mitsui Polychemicals Co., Ltd.); Surlyn 6320 (Mg), 8120 (Na), 8320 (Na), 9320 (Zn), 9320W (Zn), HPF1000 (Mg), HPF2000 (Mg) (available from E.I. du Pont de Nemours and Company); and lotek7510 (Zn), 7520 (Zn) (available from ExxonMobil Chemical Corporation). It is noted that Na, Zn, Li, Mg or the like described in the parentheses after the trade names of the ionomer resin indicate metal ion type for neutralizing the ionomer resin.

The thermoplastic polyurethane elastomer has a urethane bond in the molecule. The urethane bond may be formed by a reaction between a polyol and a polyisocyanate. The polyol which is the raw material for the urethane bond has a plurality of hydroxy groups, and a low molecular weight polyol or a high molecular weight polyol may be used.

Specific examples of the thermoplastic polyurethane elastomer include Elastollan (registered trademark) NY80A, NY84A, NY88A, NY95A, ET885, ET890 (available from BASF Japan Ltd.).

As the thermoplastic styrene based elastomer, a styrene block-containing thermoplastic elastomer can be suitably used. The styrene block-containing thermoplastic elastomer has a polystyrene block as a hard segment, and a soft segment.

The styrene block-containing thermoplastic elastomer includes a styrene-butadiene-styrene block copolymer (SBS), a styrene-isoprene-styrene block copolymer (SIS), a styrene-isoprene-butadiene-styrene block copolymer (SIBS), a hydrogenated product of SBS, a hydrogenated product of SIS, and a hydrogenated product of SIBS. Examples of the hydrogenated product of SBS include a styrene-ethylene-butylene-styrene block copolymer (SEBS). Examples of the hydrogenated product of SIS include a styrene-ethylene-propylene-styrene block copolymer (SEPS). Examples of the hydrogenated product of SIBS include a styrene-ethylene-ethylene-propylene-styrene block copolymer (SEEPS).

Examples of the thermoplastic styrene based elastomer include TEFABLOC T3221C, T3339C, SJ4400N, SJ5400N, SJ6400N, SJ7400N, SJ8400N, SJ9400N, SR04 (available from Mitsubishi Chemical Corporation).

The cover composition constituting the outermost cover preferably contains the polyurethane and/or the ionomer resin as the resin component, and particularly preferably contains the polyurethane as the resin component. If the outermost cover contains the polyurethane as the resin component, the bite of the outermost cover into the club face on a driver shot is greater, and thus the spin rate is easily increased.

In the case that the cover composition contains the polyurethane as the resin component, the amount of the polyurethane in the resin component is preferably 50 mass % or more, more preferably 60 mass % or more, and even more preferably 70 mass % or more. The resin component of the cover composition may consist of the polyurethane (preferably the thermoplastic polyurethane elastomer).

In the case that the cover composition contains the ionomer resin as the resin component, the amount of the ionomer resin in the resin component is preferably 50 mass % or more, more preferably 60 mass % or more, and even more preferably 70 mass % or more. When the ionomer resin is contained, it is also preferable that the thermoplastic styrene elastomer is used in combination.

The intermediate layer composition preferably contains the ionomer resin as the resin component. When the ionomer resin is contained, it is also preferable that the thermoplastic styrene elastomer is used in combination. The amount of the ionomer resin in the resin component of the intermediate layer composition is preferably 50 mass % or more, more preferably 60 mass % or more, and even more preferably 70 mass % or more.

The outermost cover composition and the intermediate layer composition may contain a pigment component such as a white pigment (e.g. titanium oxide), a blue pigment and a red pigment, a weight adjusting agent such as zinc oxide, calcium carbonate and barium sulfate, a dispersant, an antioxidant, an ultraviolet absorber, a light stabilizer, a fluorescent material or fluorescent brightener, or the like, in addition to the above resin component.

The amount of the white pigment (e.g. titanium oxide) is preferably 0.5 part by mass or more, more preferably 1 part by mass or more, and is preferably 10 parts by mass or less, more preferably 8 parts by mass or less, with respect to 100 parts by mass of the base resin constituting the outermost cover. If the amount of the white pigment is 0.5 part by mass or more, it is possible to impart the opacity to the cover. In addition, if the amount of the white pigment is 10 parts by mass or less, the obtained cover has better durability.

The method for forming the intermediate layer is not particularly limited, and examples thereof include a method which comprises molding the intermediate layer composition into a hemispherical half-shell in advance, covering the spherical core with two of the half-shells, and performing compression molding; and a method which comprises injection molding the intermediate layer composition directly onto the spherical core to cover the spherical core.

Examples of the method for molding the cover include a method which comprises molding the cover composition into a hollow shell, covering the spherical body having the intermediate layer formed thereon with a plurality of the hollow shells, and performing compression molding (preferably a method which comprises molding the cover composition into a hollow half-shell, covering the spherical body with two of the half-shells, and performing compression molding); and a method which comprises injection molding the cover composition directly onto the spherical body.

The golf ball body having the cover formed thereon is ejected from the mold, and is preferably subjected to surface treatments such as deburring, cleaning and sandblast where necessary.

In addition, if desired, a paint film or a mark may be formed. The thickness of the paint film is not particularly limited, and is preferably 5 μm or more, more preferably 6 μm or more, and even more preferably 7 μm or more, and is preferably 50 μm or less, more preferably 40 μm or less, and even more preferably 30 μm or less. If the thickness of the paint film is 5 μm or more, the paint film is hard to wear off even if the golf ball is used continuously, and if the thickness of the paint film is 50 μm or less, the dimple effect is fully obtained. It is noted that the effect of the present disclosure is not impaired since the paint film is very thin.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Method]

### (1) Material (Slab) Hardness (Shore D Hardness)

Sheets with a thickness of about 2 mm were produced by injection molding the intermediate layer composition or the cover composition. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore D”.

### (2) Compression Deformation Amount (mm)

The compression deformation amount was measured with a YAMADA type compression tester “SCH”. The golf ball or spherical core was placed on a metal rigid plate of the tester. A metal cylinder slowly fell toward the golf ball or spherical core. The golf ball or spherical core sandwiched between the bottom of the cylinder and the rigid plate deformed. The travelling distance of the cylinder when applying a load from an initial load of 98 N to a final load of 1275 N to the golf ball or spherical core was measured. The compression deformation amount (mm) is the travelling distance. The travelling speed of the cylinder before applying the initial load was 0.83 mm/s. The travelling speed of the cylinder when applying the load from the initial load to the final load was 1.67 mm/s.

### (3) Core Hardness Distribution (Shore C Hardness)

The hardness measured at the surface portion of the core was adopted as the surface hardness of the core. In addition, the core was cut into two hemispheres to obtain a cut plane, and the hardness at the central point of the cut plane and the hardness at the predetermined distance from the central point in the radius direction were measured. Each hardness was measured at four points, and the average value thereof was calculated. The hardness was measured with an automatic hardness tester (Digitest II, available from Bareiss company) using a testing device of “Shore C”.

### (4) Surface Hardness of Golf Ball and Surface Hardness of Intermediate Layer

The hardness measured at the land on the surface portion of the golf ball was adopted as the surface hardness of the golf ball. In addition, the hardness measured at the surface portion of the intermediate layer-covering spherical body having the intermediate layer formed on the surface of the spherical core was adopted as the surface hardness of the intermediate layer. Each hardness was measured at four points and the average value thereof was calculated. The hardness was measured with an automatic hardness tester (Digitest II, available from Bareiss company) using a testing device of “Shore C”.

### (5) Measurement of Curving Width (m) and Rolling Distance (m) on Iron Shot

A 7-iron (I #7) (“SRIXON ZX7”, Shaft hardness: X, Loft angle: 32°, available from Sumitomo Rubber Industries, Ltd.) was installed on a swing machine available from Golf Laboratories, Inc. The hitting point was set at a 10 mm point on the toe side from the face center. The golf ball was hit at a head speed of 39 m/sec, and the side spin rate right after hitting the golf ball, the rolling distance (a distance from the fall point to the stop point), and the trajectory were measured. The spin rate right after hitting the golf ball was measured by continuously taking a sequence of photographs right after hitting the golf ball. The trajectory measurement was carried out with a launch monitor “TRACK MAN 4” available from TRACK MAN Golf. As shown in FIG. 5, the trajectory viewed from the sky was plotted in a coordinate where the line connecting the launch point and the fall point is the Y axis and the perpendicular coordinate axis is the X axis (the right direction from the launch direction is +), and the maximum value in the X axis direction is defined and calculated as the curving width. The measurement was conducted twelve times for each golf ball, and the average value thereof was adopted as the measurement value for that golf ball.

### [Production of Golf Ball]

### (1) Preparation of Core Composition

According to the formulations shown in Table 1, the materials were kneaded with a kneading roll to obtain the core compositions.

TABLE 1-1

| Core No. | | A | B-1 | B-2 | B-3 | B-4 |
|---|---|---|---|---|---|---|
| Core | Polybutadiene | 100 | 100 | 00 | 100 | 100 |
| formulation | Zinc acrylate | 31.9 | 35.3 | 35.3 | 35.3 | 35.3 |
| (parts | Zinc oxide | 10 | 5 | 5 | 5 | 5 |
| by | Barium sulfate | Appropriate | Appropriate | Appropriate | Appropriate | Appropriate |
| mass) | | amount*¹⁾ | amount*¹⁾ | amount*¹⁾ | amount*¹⁾ | amount*¹⁾ |
| | Benzoic acid | 2 | — | — | — | — |
| | Bis(pentabromophenyl) disulfide | 0.4 | — | — | — | — |
| | Diphenyl disulfide | — | 0.4 | 0.4 | 0.4 | 0.4 |
| | Dicumyl peroxide | 0.7 | 0.7 | 0.7 | 0.7 | 0.7 |
| Core vulcanizing temperature (° C.) | | 150 | 160 | 160 | 160 | 160 |
| Core vulcanizing time (minute) | | 20 | 17 | 17 | 17 | 17 |
| Core diameter (mm) | | 39.5 | 39.5 | 39.1 | 38.3 | 37.9 |
| Core compression deformation amount (mm) | | 3.21 | 3.20 | 3.24 | 3.28 | 3.31 |
| Core | Hardness at 0 mm point from center | 56.1 | 68.3 | 67.9 | 67.7 | 67.4 |
| hardness | Hardness at 2.5 mm point from center | 62.4 | 72.9 | 72.7 | 72.3 | 71.8 |
| distribution | Hardness at 5 mm point from center | 66.1 | 73.3 | 73.1 | 72.8 | 72.5 |
| (Shore | Hardness at 7.5 mm point from center | 67.0 | 73.9 | 73.5 | 73.2 | 72.9 |
| C) | Hardness at 10 mm point from center | 67.3 | 74.8 | 74.6 | 74.3 | 74.1 |
| | Hardness at 12.5 mm point from center | 70.9 | 75.6 | 75.3 | 75.1 | 74.9 |
| | Hardness at 15 mm point from center | 77.6 | 78.1 | 77.9 | 77. | 77.4 |
| | Surface hardness | 81.8 | 82.3 | 81.9 | 81.7 | 81.2 |
| | Hardness difference (surface | 25.7 | 14.0 | 14.0 | 14.0 | 13.8 |
| | hardness − center hardness) | | | | | |

*¹⁾The amount of barium sulfate was adjusted such that the golf ball had a mass of 45.3 g.

TABLE 1-2

| Core No. | | C | D-1 | D-2 | E |
|---|---|---|---|---|---|
| Core | Polybutadiene | 100 | 100 | 100 | 100 |
| formulation | Zinc acrylate | 34.3 | 30.6 | 30.6 | 33.2 |
| (parts | Zinc oxide | 5 | 5 | 5 | 10 |
| by mass) | Barium sulfate | Appropriate | Appropriate | Appropriate | Appropriate |
| | | amount*¹⁾ | amount*¹⁾ | amount*¹⁾ | amount*¹⁾ |
| | Benzoic acid | — | — | — | 2 |
| | Bis(pentabromophenyl) disulfide | — | 0.4 | 0.4 | 0.4 |
| | Diphenyl disulfide | 0.4 | — | — | — |
| | Dicumyl peroxide | 0.7 | 0.7 | 0.7 | 0.7 |
| Core vulcanizing temperature (° C.) | | 150 | 155 | 155 | 170 |
| Core vulcanizing time (minute) | | 20 | 20 | 20 | 15 |
| Core diameter (mm) | | 39.5 | 39.5 | 40.1 | 39.5 |
| Core compression deformation amount (mm) | | 3.18 | 3.16 | 3.12 | 3.20 |
| Core | Hardness at 0 mm point from center | 70.7 | 64.8 | 65.1 | 55.4 |
| hardness | Hardness at 2.5 mm point from center | 71.9 | 67.7 | 67.9 | 65.1 |
| distribution | Hardness at 5 mm point from center | 72.5 | 69.3 | 69.5 | 69.6 |
| (Shore C) | Hardness at 7.5 mm point from center | 73.0 | 69.9 | 70.1 | 70.2 |
| | Hardness at 10 mm point from center | 75.5 | 72.6 | 72.8 | 70.6 |
| | Hardness at 12.5 mm point from center | 77.1 | 75.1 | 75.4 | 71.0 |
| | Hardness at 15 mm point from center | 77.7 | 79.8 | 80.2 | 76.7 |
| | Surface hardness | 79.3 | 82.2 | 82.6 | 86.2 |
| | Hardness difference (surface hardness − | 8.6 | 17.4 | 17.5 | 30.8 |
| | center hardness) | | | | |

*¹⁾The amount of barium sulfate was adjusted such that the golf ball had a mass of 45.3 g.

The materials used in Table 1 are shown as follows.
Polybutadiene: “BR-730” available from JSR Corporation
Zinc acrylate: “ZN-DA90S” available from Nisshoku Techno Fine Chemical Co., Ltd.
Zinc oxide: “Ginrei R” available from Toho Zinc Co., Ltd.
Barium sulfate: “Barium sulfate BD” available from Sakai Chemical Industry Co., Ltd.
Benzoic acid: (purity: at least 98%) available from Tokyo Chemical Industry Co. Ltd.
Bis(pentabromophenyl) disulfide: available from Kawaguchi Chemical Industry Co., Ltd.
Diphenyl disulfide: available from Sumitomo Seika Chemicals Co., Ltd.
Dicumyl peroxide: “Percumyl (registered trademark) D” available from NOF Corporation

### (2) Preparation of Intermediate Layer Composition/Cover Composition

The materials having the formulations shown in Tables 2 and 3 were extruded with a twin-screw kneading type extruder to prepare the intermediate layer compositions/cover compositions in a pellet form.

TABLE 2

| | | cover composition No. | | | | |
|---|---|---|---|---|---|---|
| Intermediate layer composition | | a | b | c | d | e |
| Formulation | Surlyn 8150 | — | 50 | — | — | — |
| (parts by mass) | Himilan 1605 | 50 | — | 47 | — | — |
| | Himilan AM7329 | 50 | 50 | 50 | — | — |
| | Himilan 1555 | — | — | — | 45 | 41 |
| | Himilan 1557 | — | — | — | 45 | 41 |
| | TEFABLOC T3221C | — | — | 3 | 10 | 18 |
| | Titanium dioxide | 4 | 4 | 4 | 4 | 4 |

| | | | | | |
|---|---|---|---|---|---|
| Hardness (Shore D) | 66 | 68 | 63 | 55 | 50 |

Surlyn (registered trademark) 8150: sodium ion neutralized ethylene-methacrylic acid copolymer ionomer resin available from E.I. du Pont de Nemours and Company
Himilan (registered trademark) 1605: sodium ion neutralized ethylene-methacrylic acid copolymer ionomer resin available from Dow-Mitsui Polychemicals Co., Ltd.
Himilan (registered trademark) AM7329: sodium ion neutralized ethylene-methacrylic acid copolymer ionomer resin available from Dow-Mitsui Polychemicals Co., Ltd.
Himilan (registered trademark) 1555: sodium ion neutralized ethylene-methacrylic acid copolymer ionomer resin available from Dow-Mitsui Polychemicals Co., Ltd.
Himilan (registered trademark) 1557: zinc ion neutralized ethylene-methacrylic acid copolymer ionomer resin available from Dow-Mitsui Polychemicals Co., Ltd.
TEFABLOC T3221C: thermoplastic styrene based elastomer available from Mitsubishi Chemical Corporation
Titanium dioxide: A-220 available from Ishihara Sangyo Kaisha, Ltd.

TABLE 3

| Intermediate layer composition/cover composition No. | | f | g | h | i |
|---|---|---|---|---|---|
| Formulation | Elastollan NY80A | 100 | — | — | — |
| (parts by mass) | Elastollan NY84A | — | 100 | — | — |
| | Elastollan NY88A | — | — | 100 | 50 |
| | Elastollan NY95A | — | — | — | 50 |
| | TINUVIN 770 | 0.2 | 0.2 | 0.2 | 0.2 |
| | Titanium dioxide | 4 | 4 | 4 | 4 |

| | | | | |
|---|---|---|---|---|
| Hardness (Shore D) | 27 | 31 | 36 | 40 |

Elastollan (registered trademark) NY80A: thermoplastic polyurethane elastomer available from BASF Japan Ltd.
Elastollan (registered trademark) NY84A: thermoplastic polyurethane elastomer available from BASF Japan Ltd.
Elastollan (registered trademark) NY88A: thermoplastic polyurethane elastomer available from BASF Japan Ltd.
Elastollan (registered trademark) NY95A: thermoplastic polyurethane elastomer available from BASF Japan Ltd.
TINUVIN (registered trademark) 770: hindered amine based light stabilizer available from BASF Japan Ltd.
Titanium dioxide: A-220 available from Ishihara Sangyo Kaisha, Ltd.

### (3) Production of Core

The core compositions shown in Table 1 were heat-pressed in upper and lower molds, each having a hemispherical cavity, to produce the spherical cores. It is noted that barium sulfate was added in an appropriate amount such that the obtained golf balls had a mass of 45.3 g.

### (4) Formation of Intermediate Layer and Cover

The intermediate layer composition was injection molded on the spherical core to obtain the intermediate layer-covering spherical body. The obtained intermediate layer-covering spherical body was charged into a final mold provided with a plurality of pimples on the cavity surface. Half shells were obtained from the cover composition by a compression molding method. The intermediate layer-covering spherical body charged into the final mold was covered with two of the half shells to obtain the golf balls having an outermost cover on which a plurality of dimples with an inverted shape of the pimple shape on the cavity surface were formed. The specifications of the dimples formed on the outermost cover are shown in Tables 4 to 5. The evaluation results regarding the obtained golf balls are shown in Tables 6 to 7.

TABLE 4

| | | | | | | | Lower | Total |
|---|---|---|---|---|---|---|---|---|
| Dimple | | | Diameter | Depth | Depth | Curvature | volume | lower volume |
| pattern | Type | Number | (mm) | Dp1 (mm) | Dp2 (mm) | CR (mm) | (mm³) | Vi (mm³) |
| I | A | 60 | 4.400 | 0.2013 | 0.0876 | 27.7 | 0.67 | 40 |
| | B | 158 | 4.285 | 0.1954 | 0.0876 | 26.2 | 0.63 | 100 |
| | C | 72 | 4.150 | 0.1887 | 0.0876 | 24.6 | 0.59 | 43 |
| | D | 36 | 3.875 | 0.1757 | 0.0876 | 21.5 | 0.52 | 19 |
| | E | 12 | 3.000 | 0.1404 | 0.0876 | 12.9 | 0.31 | 4 |
| II | A | 60 | 4.400 | 0.2186 | 0.1049 | 23.1 | 0.80 | 48 |
| | B | 158 | 4.285 | 0.2127 | 0.1049 | 21.9 | 0.76 | 120 |
| | C | 72 | 4.150 | 0.2060 | 0.1049 | 20.6 | 0.71 | 51 |
| | D | 36 | 3.875 | 0.1930 | 0.1049 | 17.9 | 0.62 | 22 |
| | E | 12 | 3.000 | 0.1577 | 0.1049 | 10.8 | 0.37 | 4 |
| III | A | 60 | 4.400 | 0.2356 | 0.1219 | 19.9 | 0.93 | 56 |
| | B | 158 | 4.285 | 0.2297 | 0.1219 | 18.9 | 0.88 | 139 |
| | C | 72 | 4.150 | 0.2230 | 0.1219 | 17.7 | 0.83 | 59 |
| | D | 36 | 3.875 | 0.2100 | 0.1219 | 15.5 | 0.72 | 26 |
| | E | 12 | 3.000 | 0.1747 | 0.1219 | 9.3 | 0.43 | 5 |
| IV | A | 60 | 4.400 | 0.2526 | 0.1389 | 17.5 | 1.06 | 63 |
| | B | 158 | 4.285 | 0.2467 | 0.1389 | 16.6 | 1.00 | 158 |
| | C | 72 | 4.150 | 0.2400 | 0.1389 | 15.6 | 0.94 | 68 |
| | D | 36 | 3.875 | 0.2270 | 0.1389 | 13.6 | 0.82 | 30 |
| | E | 12 | 3.000 | 0.1917 | 0.1389 | 8.2 | 0.49 | 6 |
| V | A | 60 | 4.400 | 0.2696 | 0.1559 | 15.6 | 1.19 | 71 |
| | B | 158 | 4.285 | 0.2637 | 0.1559 | 14.8 | 1.13 | 178 |
| | C | 72 | 4.150 | 0.2570 | 0.1559 | 13.9 | 1.06 | 76 |
| | D | 36 | 3.875 | 0.2440 | 0.1559 | 12.1 | 0.92 | 33 |
| | E | 12 | 3.000 | 0.2087 | 0.1559 | 7.3 | 0.55 | 7 |

TABLE 5

| Dimple pattern No. | I | II | III | IV | V |
|---|---|---|---|---|---|
| Front view | FIG. 2 | FIG. 2 | FIG. 2 | FIG. 2 | FIG. 2 |
| Plane view | FIG. 3 | FIG. 3 | FIG. 3 | FIG. 3 | FIG. 3 |
| Total number | 338 | 338 | 338 | 338 | 338 |
| Total lower | 205 | 245 | 285 | 325 | 365 |
| volume Vi (mm³) | | | | | |
| Occupation ratio (%) | 81.6 | 81.6 | 81.6 | 81.6 | 81.6 |

TABLE 6-1

| Golf ball No. | | 1 | 2 | 3 | 4 | 5 | 6 |
|---|---|---|---|---|---|---|---|
| Core | Formulation | B-1 | B-1 | B-1 | B-2 | C | B-3 |
| | Diameter (mm) | 39.5 | 39.5 | 39.5 | 39.1 | 39.5 | 38.3 |
| | Compression deformation amount (mm) | 3.2 | 3.2 | 3.2 | 3.24 | 3.18 | 3.28 |
| | Core center hardness Ho (Shore C) | 68.3 | 68.3 | 68.3 | 67.9 | 70.7 | 67.7 |
| | Hardness H10 at 10 mm point (Shore C) | 74.8 | 74.8 | 74.8 | 74.6 | 75.5 | 74.3 |
| | Core surface hardness Hs (Shore C) | 82.3 | 82.3 | 82.3 | 81.9 | 79.3 | 81.7 |
| | (H10 − Ho)/S | 0.46 | 0.46 | 0.46 | 0.48 | 0.56 | 0.47 |
| | S = Hs − Ho | 14.0 | 14.0 | 14.0 | 14.0 | 8.6 | 14.0 |
| Intermediate | Formulation | c | c | c | c | c | c |
| layer | Thickness Tm (mm) | 1.0 | 1.0 | 1.0 | 1.0 | 1.0 | 1.6 |
| | Surface hardness Hms (Shore C) | 92 | 92 | 92 | 92 | 92 | 92 |
| | Material hardness Hm (Shore D) | 63 | 63 | 63 | 63 | 63 | 63 |
| Cover | Formulation | g | g | g | g | g | f |
| | Thickness Tc (mm) | 0.6 | 0.6 | 0.6 | 0.8 | 0.6 | 0.6 |
| | Material hardness Hc (Shore D) | 31 | 31 | 31 | 31 | 31 | 27 |
| Dimple | Pattern No | II | III | I | III | III | III |
| | Total lower volume Vi (mm³) | 245 | 285 | 205 | 245 | 285 | 285 |
| Ball | Surface hardness Hcs (Shore C) | 84 | 84 | 84 | 79 | 84 | 82 |
| | Compression deformation amount (mm) | 2.79 | 2.79 | 2.79 | 2.82 | 2.77 | 2.71 |
| (S × (Hm × Tm + H × Tc)/(Tm + Tc)) × Vi/1000 | | 174.9 | 203.5 | 146.4 | 167.3 | 125.0 | 212.2 |
| I#7 39 m/s | Side spin rate (rpm) | 470 | 470 | 470 | 540 | 580 | 500 |
| toe 10 mm | Curving width (m) | 7.2 | 6.4 | 7.9 | 7.8 | 7.6 | 6.6 |
| | Rolling distance (m) | 9.8 | 10.4 | 9.1 | 9.4 | 9.1 | 10.3 |

TABLE 6-2

| Golf ball No. | | 7 | 8 | 9 | 10 | 11 | 12 |
|---|---|---|---|---|---|---|---|
| Core | Formulation | B-3 | D-1 | B-1 | D-1 | B-4 | B-4 |
| | Diameter (mm) | 38.3 | 39.5 | 39.5 | 39.5 | 37.9 | 37.9 |
| | Compression deformation amount (mm) | 3.28 | 3.16 | 3.2 | 3.16 | 3.31 | 3.31 |
| | Core center hardness Ho (Shore C) | 67.7 | 64.8 | 68.3 | 64.8 | 67.4 | 67.4 |
| | Hardness H10 at 10 mm point (Shore C) | 74.3 | 72.6 | 74.8 | 72.6 | 74.1 | 74.1 |
| | Core surface hardness Hs (Shore C) | 81.7 | 82.2 | 82.3 | 82.2 | 81.2 | 81.2 |
| | (H10 − Ho)/S | 0.47 | 0.45 | 0.46 | 0.45 | 0.49 | 0.49 |
| | S = Hs − Ho | 14.0 | 17.4 | 14.0 | 17.4 | 13.8 | 13.8 |
| Intermediate | Formulation | c | c | d | e | c | d |
| layer | Thickness Tm (mm) | 1.6 | 1.0 | 1.0 | 1.0 | 1.6 | 1.4 |
| | Surface hardness Hms (Shore C) | 92 | 92 | 83 | 76 | 92 | 83 |
| | Material hardness Hm (Shore D) | 63 | 63 | 55 | 50 | 63 | 55 |
| Cover | Formulation | g | f | g | f | g | i |
| | Thickness Tc (mm) | 0.6 | 0.6 | 0.6 | 0.6 | 0.8 | 1.0 |
| | Material hardness Hc (Shore D) | 31 | 27 | 31 | 27 | 31 | 40 |
| Dimple | Pattern No. | III | II | II | II | III | III |
| | Total lower volume Vi (mm³) | 285 | 245 | 245 | 245 | 285 | 285 |
| Ball | Surface hardness Hcs (Shore C) | 84 | 82 | 78 | 68 | 79 | 76 |
| | Compression deformation amount (mm) | 2.69 | 2.71 | 2.87 | 2.86 | 2.82 | 2.82 |
| (S × (Hm × Tm + H × Tc)/(Tm + Tc)) × Vi/1000 | | 216.5 | 211.0 | 157.8 | 176.4 | 205.8 | 191.7 |
| I#7 39 m/s | Side spin rate (rpm) | 420 | 450 | 560 | 620 | 490 | 520 |
| toe 10 mm | Curving width (m) | 6.1 | 6.9 | 7.9 | 8.4 | 6.5 | 6.8 |
| | Rolling distance (m) | 11 | 10.1 | 9.2 | 8.6 | 10.5 | 10.1 |

TABLE 7

| Golf ball No. | | 13 | 14 | 15 | 16 | 17 | 18 | 19 | 20 | 21 |
|---|---|---|---|---|---|---|---|---|---|---|
| Core | Formulation | D-1 | D-1 | D-1 | D-2 | E | A | D-1 | D-1 | A |
| | Diameter (mm) | 39.5 | 39.5 | 39.5 | 40.1 | 39.5 | 39.5 | 39.5 | 39.5 | 39.5 |
| | Compression | 3.16 | 3.16 | 3.16 | 3.12 | 3.2 | 3.21 | 3.16 | 3.16 | 3.21 |
| | deformation amount | | | | | | | | | |
| | (mm) | | | | | | | | | |
| | Core center | 64.8 | 64.8 | 64.8 | 65.1 | 55.4 | 56.1 | 64.8 | 64.8 | 56.1 |
| | hardness Ho (Shore C) | | | | | | | | | |
| | Hardness H10 at 10 | 72.6 | 72.6 | 72.6 | 72.8 | 70.6 | 67.3 | 72.6 | 72.6 | 67.3 |
| | mm point (Shore C) | | | | | | | | | |
| | Core surface | 82.2 | 82.2 | 82.2 | 82.6 | 86.2 | 81.8 | 82.2 | 82.2 | 81.8 |
| | hardness Hs (Shore C) | | | | | | | | | |
| | (H10 − Ho)/S | 0.45 | 0.45 | 0.45 | 0.44 | 0.49 | 0.44 | 0.45 | 0.45 | 0.44 |
| | Hardness difference | 17.4 | 17.4 | 17.4 | 17.5 | 30.8 | 25.7 | 17.4 | 17.4 | 25.7 |
| | S = Hs − Ho | | | | | | | | | |
| Intermediate | Formulation | c | c | b | c | d | c | a | c | b |
| layer | Thickness Tm (mm) | 1.0 | 1.0 | 1.0 | 1.0 | 1.0 | 1.0 | 1.0 | 1.0 | 1.0 |
| | Surface hardness | 92 | 92 | 97 | 92 | 83 | 92 | 95 | 92 | 97 |
| | Hms (Shore C) | | | | | | | | | |
| | Material hardness | 63 | 63 | 68 | 63 | 55 | 63 | 66 | 63 | 68 |
| | Hm (Shore D) | | | | | | | | | |
| Cover | Formulation | g | g | h | g | f | g | g | e | f |
| | Thickness Tc (mm) | 0.6 | 0.6 | 0.6 | 0.3 | 0.6 | 0.6 | 0.6 | 0.6 | 0.6 |
| | Material hardness | 31 | 31 | 31 | 31 | 27 | 31 | 31 | 50 | 31 |
| | Hc (Shore D) | | | | | | | | | |
| Dimple | Pattern No. | IV | V | IV | IV | III | III | III | III | III |
| | Total lower volume | 325 | 365 | 325 | 325 | 285 | 285 | 285 | 285 | 285 |
| | Vi (mm³) | | | | | | | | | |
| Ball | Surface hardness | 84 | 84 | 88 | 86 | 75 | 84 | 87 | 86 | 88 |
| | Hcs (Shore C) | | | | | | | | | |
| | Compression | 2.75 | 2.75 | 2.71 | 2.77 | 2.89 | 2.8 | 2.74 | 2.65 | 2.75 |
| | deformation amount | | | | | | | | | |
| | (mm) | | | | | | | | | |
| (S × (Hm × Tm + Hc × Tc)/(Tm + Tc)) × Vi/1000 | | 288.4 | 323.9 | 306.1 | 316.3 | 390.6 | 373.5 | 262.2 | 288.2 | 396.4 |
| I#7 39 m/s | Side spin rate (rpm) | 420 | 420 | 370 | 320 | 330 | 360 | 400 | 380 | 280 |
| toe 10 mm | Curving width(m) | 5.4 | 4.9 | 4.7 | 4.4 | 5.5 | 5.6 | 5.8 | 5.7 | 4.1 |
| | Rolling distance (m) | 11.6 | 12.2 | 12.9 | 13.5 | 12.2 | 12 | 11.4 | 1.8 | 13.6 |

It is apparent that the golf ball according to the present disclosure that comprises a spherical core, an intermediate layer positioned outside the spherical 5 core, and an outermost cover positioned outside the intermediate layer and having a plurality of dimples formed thereon, wherein
a hardness difference S(=Hs−Ho) between a center hardness Ho (Shore C hardness) of the spherical core and a surface hardness Hs (Shore C hardness) of the spherical core,
a material hardness Hm (Shore D hardness) of the intermediate layer,
a thickness Tm (mm) of the intermediate layer,
a material hardness Hc (Shore D hardness) of the outermost cover,
a thickness Tc (mm) of the outermost cover, and
a total lower volume Vi (mm³) of the plurality of dimples satisfy
[S×(Hm×Tm+Hc×Tc)]/(Tm+Tc)×Vi/1000<230, curves to a large extent and rolls a short distance after landing.

The preferable embodiment (1) according to the present disclosure is a golf ball comprising a spherical core, an intermediate layer positioned outside the spherical core, and an outermost cover positioned outside the intermediate layer and having a plurality of dimples formed thereon, wherein
a hardness difference S(=Hs−Ho) between a center hardness Ho (Shore C hardness) of the spherical core and a surface hardness Hs (Shore C hardness) of the spherical core,
a material hardness Hm (Shore D hardness) of the intermediate layer,
a thickness Tm (mm) of the intermediate layer,
a material hardness Hc (Shore D hardness) of the outermost cover,
a thickness Tc (mm) of the outermost cover, and
a total lower volume Vi (mm³) of the plurality of dimples satisfy

[S×(Hm×Tm+Hc×Tc)]/(Tm+Tc)×Vi/1000<230.

The preferable embodiment (2) according to the present disclosure is the golf ball according to the embodiment (1), wherein 0.35<(H10−Ho)/S<0.6 is satisfied where H10 is a hardness at a 10 mm point from a center of the spherical core.

The preferable embodiment (3) according to the present disclosure is the golf ball according to the embodiment (1) or (2), wherein the hardness difference S<20.

The preferable embodiment (4) according to the present disclosure is the golf ball according to any one of the embodiments (1) to (3), wherein Vi<300.

The preferable embodiment (5) according to the present disclosure is the golf ball according to any one of the embodiments (1) to (4), wherein the surface hardness Hs (Shore C hardness) of the spherical core<a surface hardness Hms (Shore C hardness) of the intermediate layer>a surface hardness Hcs (Shore C hardness) of the golf ball is satisfied.

The preferable embodiment (6) according to the present disclosure is the golf ball according to any one of the embodiments (1) to (5), wherein the outermost cover contains a polyurethane as a resin component.

This application is based on Japanese Utility application No. 2023-002195 filed on Jun. 22, 2023, the content of which is hereby incorporated by reference.

1. A golf ball comprising a spherical core, an intermediate layer positioned outside the spherical core, and an outermost cover positioned outside the intermediate layer and having a plurality of dimples formed thereon, wherein
a hardness difference S(=Hs−Ho) between a center hardness Ho (Shore C hardness) of the spherical core and a surface hardness Hs (Shore C hardness) of the spherical core,
a material hardness Hm (Shore D hardness) of the intermediate layer,
a thickness Tm (mm) of the intermediate layer,
a material hardness Hc (Shore D hardness) of the outermost cover,
a thickness Tc (mm) of the outermost cover, and
a total lower volume Vi (mm³) of the plurality of dimples
satisfy [S×(Hm×Tm+Hc×Tc)]/(Tm+Tc)×Vi/1000<230.

2. The golf ball according to claim 1, wherein 0.35<(H10−Ho)/S<0.6 is satisfied where H10 is a hardness at a 10 mm point from a center of the spherical core.

3. The golf ball according to claim 1, wherein the hardness difference S<20.

4. The golf ball according to claim 1, wherein Vi<300.

5. The golf ball according to claim 1, wherein the surface hardness Hs (Shore C hardness) of the spherical core<a surface hardness Hms (Shore C hardness) of the intermediate layer>a surface hardness Hcs (Shore C hardness) of the golf ball is satisfied.

6. The golf ball according to claim 1, wherein the outermost cover contains a polyurethane as a resin component.

7. The golf ball according to claim 1, wherein
110≤[S×(Hm×Tm+Hc×Tc)]/(Tm+Tc)×Vi/1000<230 is satisfied.

8. The golf ball according to claim 1, wherein the center hardness Ho of the spherical core ranges from 45 to 74 in Shore C hardness.

9. The golf ball according to claim 1, wherein the surface hardness Hs of the spherical core ranges from 60 to 95 in Shore C hardness.

10. The golf ball according to claim 1, wherein the thickness Tm of the intermediate layer ranges from 0.8 mm to 3.0 mm.

11. The golf ball according to claim 1, wherein the thickness Tc of the outermost cover ranges from 0.4 mm to 1.0 mm.

12. The golf ball according to claim 1, wherein the material hardness Hm of the intermediate layer ranges from 50 to 73 in Shore D hardness.

13. The golf ball according to claim 1, wherein the material hardness Hc of the outermost cover ranges from 20 to 40 in Shore D hardness.

14. The golf ball according to claim 1, wherein a product (Hm×Tm) obtained by multiplying the material hardness Hm (Shore D hardness) of the intermediate layer by the thickness Tm (mm) of the intermediate layer ranges from 50 to 140.

15. The golf ball according to claim 1, wherein a product (Hc×Tc) obtained by multiplying the material hardness Hc (Shore D hardness) of the outermost cover by the thickness Tc (mm) of the outermost cover ranges from 10 to 45.

16. The golf ball according to claim 1, wherein a total thickness (Tm+Tc) of the thickness Tm of the intermediate layer and the thickness Tc of the outermost cover ranges from 1.2 mm to 3.5 mm.

17. The golf ball according to claim 2, wherein the hardness H10 at the 10 mm point from the center of the spherical core ranges from 60 to 84 in Shore C hardness.
